(19) United States
(12) Patent Application Publication
(10) Pub. No.: US 2009/0248224 A1
(43) Pub. Date: Oct. 1, 2009

(54) Integrated Air Navigation and Flight Control System

(76) Inventor: Kurt Tschannen, Zurich (CH)

Correspondence Address: PAULEY PETERSEN & ERICKSON, 2800 WEST HIGGINS ROAD, SUITE 365, HOFFMAN ESTATES, IL, 60169, US

(21) Appl. No.: 10/582,059

(22) PCT Filed: Oct. 1, 2004
(86) PCT No.: PCT/CH04/00609

§ 371 Date: May 25, 2007

(30) Foreign Application Priority Data
Oct. 3, 2003 (CH) 168/03

(51) Int. Cl. G01C 23/00; G05D 1/00; G08G 5/06; G08G 5/02; G08G 5/00

(52) U.S. Cl. 701/3

(57) ABSTRACT

A method and a device for solving air traffic congestions, improve safety, and reduce faults to simplify cockpit equipment. The method serves the navigation of airplanes from port to port with the help of GPS signals. The navigation support is based on digital maps and position control by GPS signals, which GPS signals are corrected by GPS reference signals wherein depending on the present position and state of motion of the airplane the map is respectively the movement is selected automatically from a library and shown on a screen.

### BACKGROUND OF THE INVENTION

### Field of the Invention

This invention relates to a method and a device for an integrated air navigation and flight control system.

### SUMMARY OF THE INVENTION

The new air navigation and flight control system helps solve air traffic congestion, improve safety, reduce human factors errors, simplify cockpit equipment, and increase capacity limitations in North Atlantic and Pacific airspace, in continental airspace and in terminal areas of airports around the world.

The new system will allow aircrafts to take advantage of reduced separation and follow optimized flight paths by using GNSS navigation. The system will save time and fuel costs and thus minimize air pollution, and it increases aircraft utilization and brings efficiency benefits to the airlines. It is designed to minimize cockpit workload, cut interpretation time and cutout input errors, such as caused by inadvertent entering of wrong coordinates into the aircraft navigation system. With the integrated terrain database, controlled flight into terrain (CFIT) will be omitted. It will enable CAT I, II and III approaches to non-ILS equipped airports, thereby increasing the reliability of scheduled flights and omitting costs arising with alternate landings. With its giant integration technology one is no longer forced to buy, install and maintain many different kinds of cockpit instruments and equipment thus considerably saving the airline operators budget.

### BRIEF DESCRIPTION OF THE DRAWINGS

This invention is described in connection with the following figures, wherein:

FIG. 1 shows a perspective view of a device ready for mounting in the cockpit of an airplane, according to this invention;

FIG. 2 shows a view of a conventional cockpit of a cabin class twin;

FIG. 3 shows the same cockpit but with a number of new devices, each showing different functions;

FIG. 4 shows a screen device displaying a runway card;

FIG. 5 shows a screen device displaying a departure card;

FIG. 6 shows a screen device displaying an enroute card;

FIG. 7 shows a device displaying an approach card and a glide path indicator;

FIG. 8 shows a device displaying a 3-D approach tunnel, with an approach on centerline;

FIG. 9 shows a device displaying a 3-D approach tunnel, with an approach right of centerline;

FIG. 10 shows a device displaying en route with a 3-D terrain option in IMC condition;

FIG. 11 shows a device displaying an approach with a 3-D terrain option in IMC condition;

FIG. 12 shows a meteo information screen from an electronic cockpit library;

FIG. 13 shows an en route card with ground proximity warning and terrain profile;

FIG. 14 shows a primary flight display with horizon and other indications;

FIG. 15 shows a display of satellite weather;

FIG. 16 shows a display of communication functions;

FIG. 17 shows a screen with a display of conventional engine instruments;

FIG. 18 shows a software type schematic dataflow room and to the device; and

FIG. 19 shows a diagram of software networking of the software modules.

### DETAILED DESCRIPTION OF THE INVENTION

The method and device of this invention is the first highly integrated system that offers:

a. full pictorial navigation from gate to gate, increasing flight safety on ground and in the air, tremendously;

b. an integrated electronic cockpit library relieving the pilots from doing paper work while flying;

c. a pictorial of GNSS 3-D approach tunnels guiding the pilot safely down to a runway threshold;

d. CAT I, II and III precision differential GNSS approaches to any non-ILS equipped airfield on the globe, enabling new destinations;

e. a forward looking ground proximity warning, avoiding controlled flight into terrain;

f. an integrated collision avoidance on ground and in the air, increasing safety for passengers, crew, aircraft and cargo;

g. an advanced PFD (Primary Flight Display) with integrated FMS (Flight Management System);

h. an integrated flight recorder functions for safety, training and analysis;

i. a data link for ATM (Air Traffic Management) for safe guidance in the air and on ground;

j. actual weather satellite pictures from an aircraft present position, destination or any other place of interest; and

k. a moving 3-D terrain depiction, enabling a pilot to see a terrain even if the pilot is in complete IMC or at night which provides the pilot with a tremendous safety margin and omits CFIT.

For easier writing and reading the method and device the global Integrated Air Navigation and Flight Control System in the following description is referred to as “GIANS”.

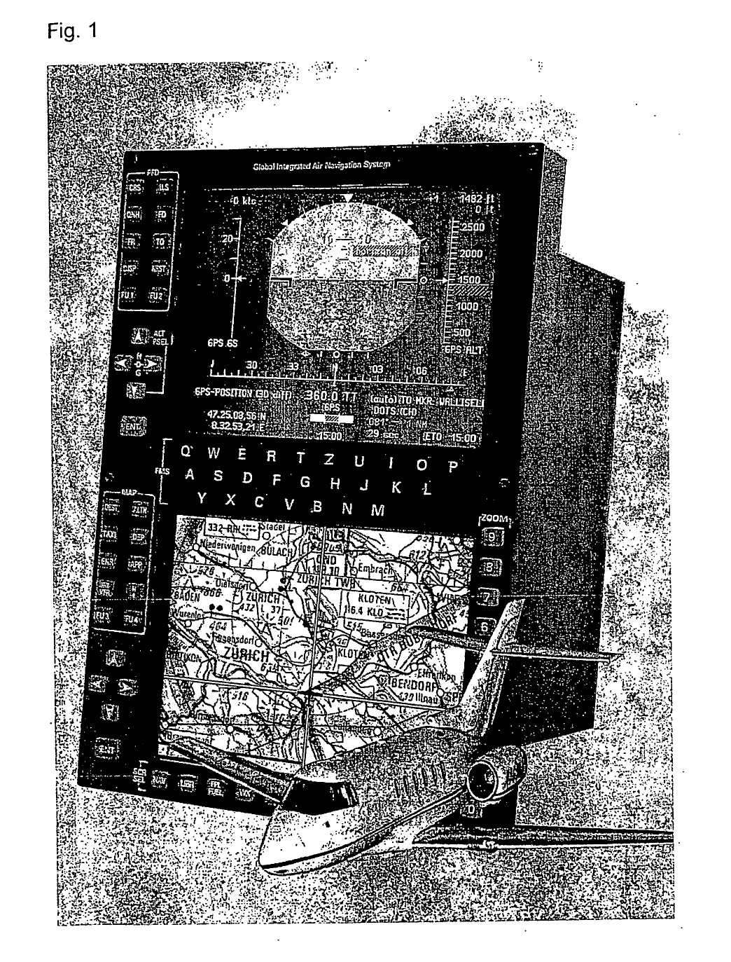

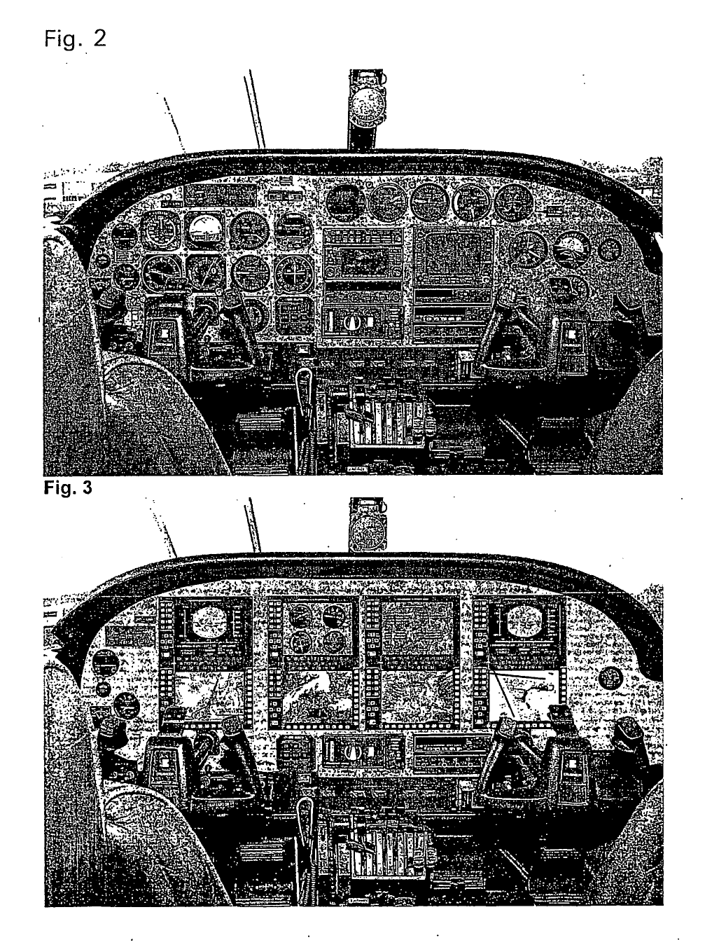

GIANS is compact and lightweight, compared to today's normal equipment and it costs and weighs only a fraction of known equipment and needs much the less electrical power (FIG. 1). The system of this invention is an efficient and safe tool for professional navigation, cockpit and flight management (FIGS. 2 and 3) and provides:

Advanced primary flight display;

Integrated electronic cockpit library;

True digitized moving maps;

Integrated coupled flight planning;

Integrated differential GNSS receiver;

Worldwide FMS database;

Terrain depiction and warnings;

Satellite weather picture reception;

User specific 3-D approach tunnels; and

Replacement for many cockpit instruments.

These are only a few of the advantages offered by the high-tech stand alone navigation and flight control system GIANS, according to this invention.

In the following discussion, the features and possibilities of GIANS are declared while operating an airplane from port to port.

### Taxi

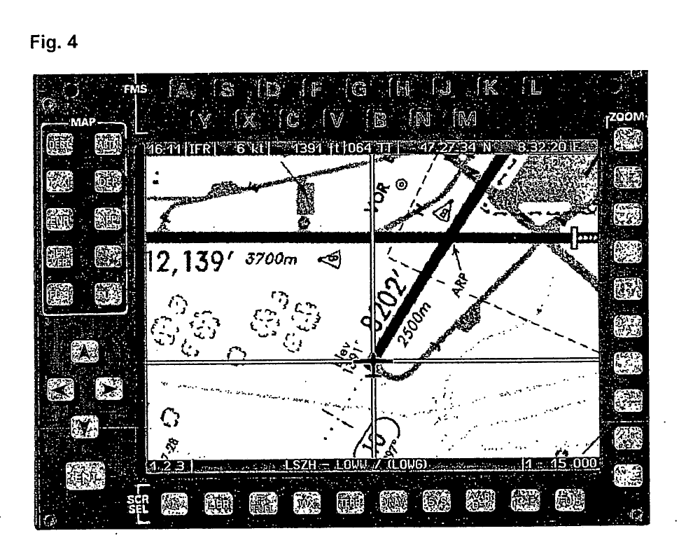

When starting engines the system presents automatically the taxi chart the pilot is used to, with position on the apron. While taxiing out, the chart will move and turn and thus track and position. The pilot sees the apron move on the display as he would see it when looking out of his window. While lining up, the pilot sees what runway he is entering. With this invention, there are no worries about where the aircraft's stand is and which taxiway to take on larger airports, and no more accidents in foggy conditions or at night due to unintended entering of a runway or the wrong runway (FIG. 4).

### Lining Up And Departure

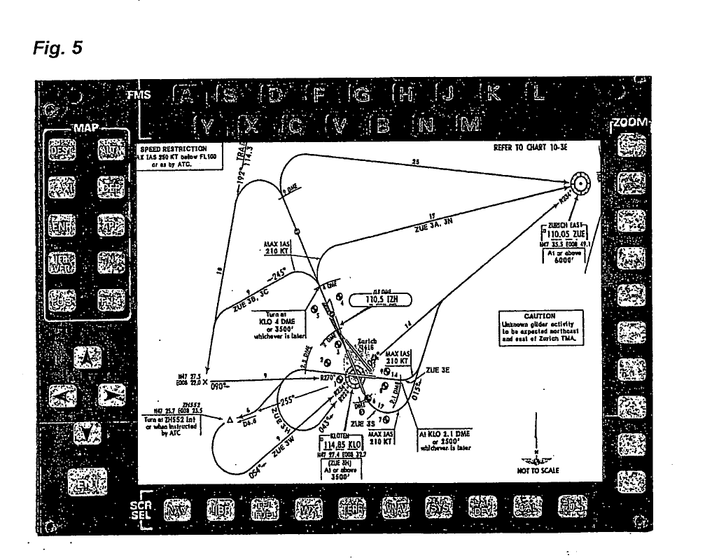

This invention can select the appropriate departure chart according to the pilot's IFR or VFR clearance. The pilot can read an IFR clearance on the display. At departure the system presents automatically the aircraft's track, position, altitude and elapsed time, without touching any button. Take off time is stored and displayed. The pilot only has to follow the departure route on the displayed chart (FIG. 5).

No more airway manuals are necessary in the cockpit. There is no more hasty reaching for departure charts in and out of the airway manuals and no more losing sheets beneath the pilot's seat, and no more attaching the sheet to the pilot's steering wheel, covering parts of the lower instrument panel, and no more entering coordinates and no risk of being shot at due to navigation error.

### Enroute

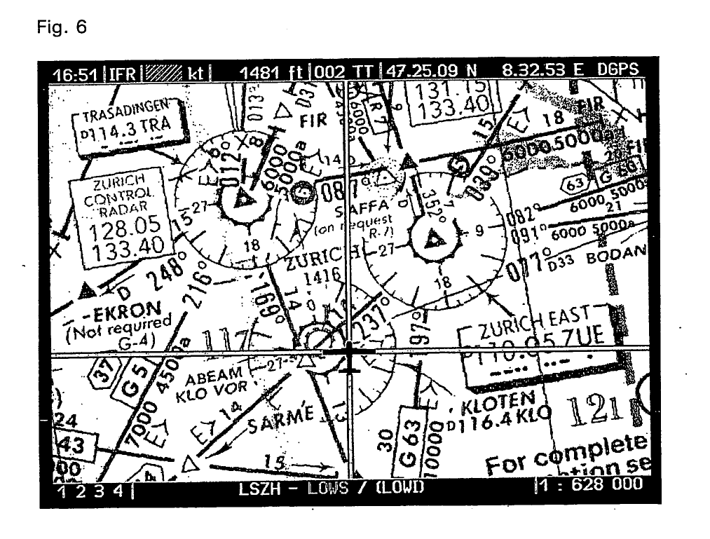

When approaching the border of the departure chart, the pilot's high-level or low level enroute chart with the airplane's position and track appears on the display, again without touching any button. If the pilot wants to cancel IFR and continue VFR or vice versa the pilot only needs to press a button and the System will change to the appropriate maps and charts. Rotary wing aircraft can operate with obstruction maps 1:100 000 or better (FIG. 6).

If the pilot has some time enroute the pilot can study the Destination Area and approach charts, weather frequencies, or any other chart of interest by changing to the library mode and the pilot has access to every desired map or chart or text or checklist. With the weather option installed, the pilot has direct access to the newest satellite weather picture, independent of the aircraft's position, whether in the air or on ground, whether on a polar flight or crossing the equator.

### Approach

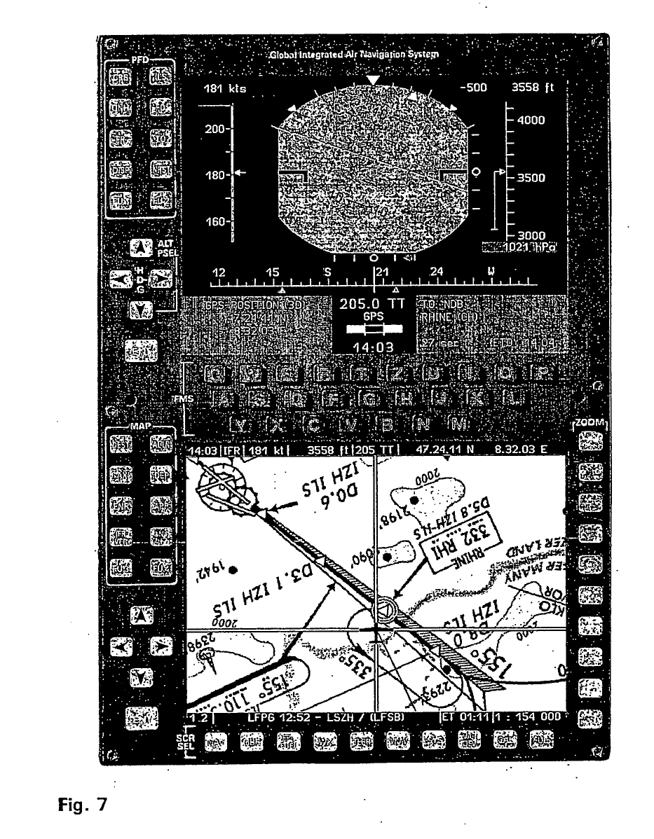

When approaching the destination, the pilot's area or approach chart with actual position and track appears on the display automatically, again without touching any button or they can be selected manually. All the pilot has to do is to follow the approach line on the chart. If Radar permits, the pilot may shorten the approach as shown on the Figure (FIG. 7).

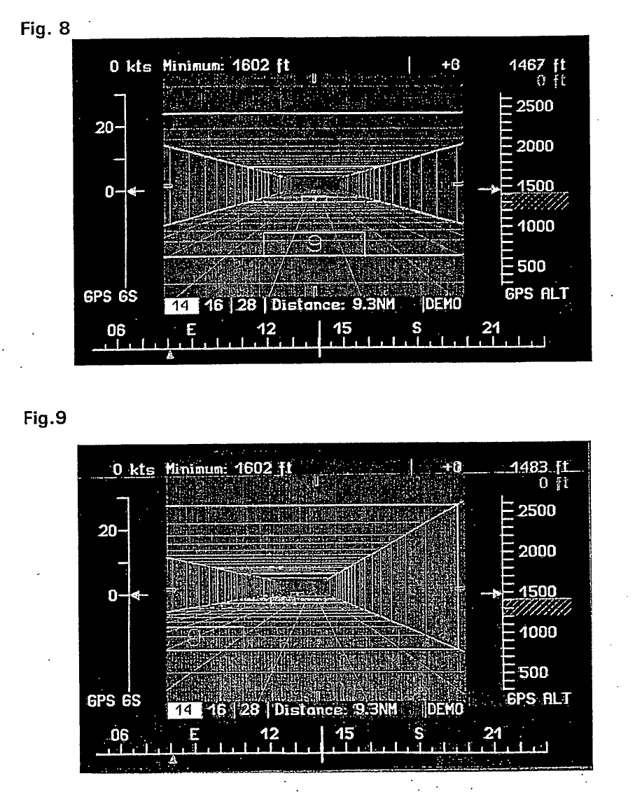

And finally a curved or straight 3-D approach tunnel, a customer's option, with distances, altitudes and checkpoint marks will guide the pilot safely to the runway. This feature will enable the pilot to make safe approaches and go around at difficult airports, such as when surrounded by high terrain (FIGS. 8-10).

### Alternate

To divert to an alternate the pilot only has to activate, the alternate, and the appropriate charts will appear on the pilot's screen.

### On Ground

When landed, the system will automatically show the pilot the necessary taxi charts and stands, and the aircraft's position and track on the apron. Landing time and elapsed time are automatically stored and displayed.

### The Systems Capabilities and Features

### True Mapping on the Navigation Display (ND)

The systems true mapping, based on GNSS, offers a fully automatic or manual, as the pilot prefers, selection of any kind of real map, e.g. Taxi, Departure, Enroute, Area, Approach and Landing charts, colored or non-colored. They are positioned and turned and moved according the aircraft's present position and track and speed. On the screen the pilot see the same landscape positioned in the same manner as the pilot would see it when looking out of the windows. All maps and charts can be zoomed. The pilot can further select whether he wants only IFR or only VFR maps and charts. A simple ‘North up’ feature allows the pilot not only to read the text on a turned map better, but also to continue positioning in north up configuration of the maps and charts, if desired.

Human interpretation time of navigation instrument readings is drastically reduced, thus enabling faster reaction and a better plan. Navigation errors are omitted.

### Additional Information on the ND

In addition, the track, position in latitude and longitude, altitude, ground speed, time in UTC, departure, destination and alternate, elapsed time, zoom factor and map scale are displayed simultaneously.

### Track Beam

A track beam enables the pilot to verify and fix the aircraft's course to any point of interest around the aircraft or to circumnavigate heavy weather or danger areas.

### Forward Moving Estimate

It is a help when a pilot knows in how many minutes and at what time the aircraft is overhead, a certain position ahead. The Pilot can project the remaining flight time and the ETO over a map at the point the pilot will reach it.

### Electronic Cockpit Library

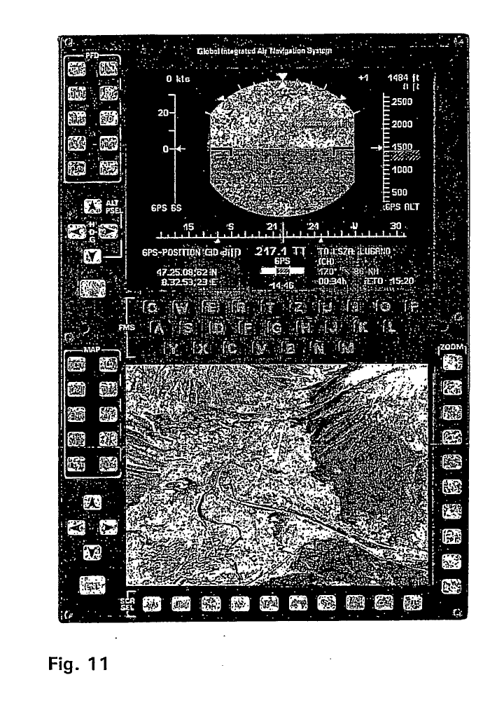

An Electronic Cockpit Library allows the pilot to display whatever document he wishes to have present, e.g. maps, checklists, airport data, radio aids, meteorology, tables and codes, procedures, entry requirements, AFM and technical manuals, and even hotels and restaurants at the destination or alternate for the comfort of crew and passengers. The number of documents depends on the customers needs and can be customized (FIG. 11).

### Displays

The System comes with two fast, full color and lightweight flat panel displays allowing to present any colored, black and white or grayscale image or text. Contrary to known standard cockpit CRT's the GIANS-display allows the simultaneous depiction of complex varieties of multi-colored, multi-shaded patterns. Furthermore, the GIANS-display has no eye or body harming radiation.

### Keyboard

The keyboard is integrated in the display unit. An external keyboard may also be used, which is user-friendly, simple in handling and offering color-coded, clearly arranged functional blocks. There is no need to enter coordinates and thus there is no chance for erroneous inputs. Night operation is comfortable as well because the lighting of the keyboard blocks corresponds to its daylight colors. It is automatically dimmed with the airplanes instrument panel dimmer allowing the pilot the amount of desired light. In case of an airplane electrical power failure all GIANS-systems continue to work normally on the system-integrated optional battery pack when installed, including the keyboard lighting.

### Replacement of Cockpit Instrumentation

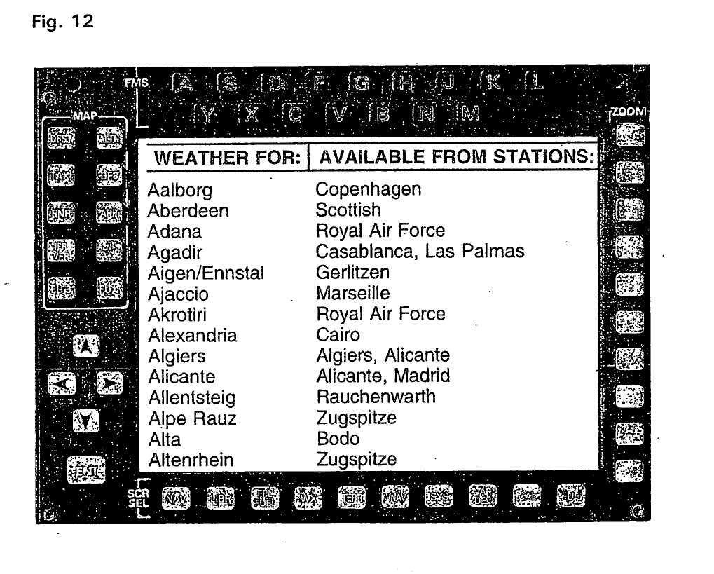

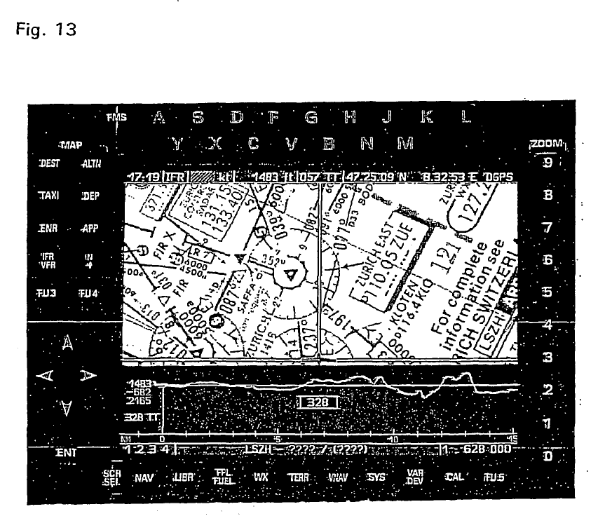

The System is capable of replacing the following Cockpit Instruments and systems: ADF, VOR, HSI, DME, ILS, MLS, RNAV, LORAN, OMEGA, INS, FMS (in accordance with aircraft and engine data and the degree of automation), EFIS, EVS, GPW, EGPW, and, when ATC is ready for it (data uplink and downlink to and from aircraft established), and TCAS. FAA considers GNSS as a primary navigational means (FIGS. 12, 13).

### Approach Channel

A 3-D tunnel-like approach channel can be used to enable the pilot to enter a tunnel that leads him safely to the runway while giving a continuous visual 3-D picture of the ILS limits, the aircraft's position, distance to the runway, required altitudes and checkpoint marks, colored marker beacons, etc. The approach channel is not limited to ILS equipped airports and can be custom tailored (FIGS. 8 and 9).

### Precision Approaches

The System is equipped with a differential receiver for differential GNSS signal reception enabling satellite based ILS Cat 1,2 and 3 approaches.

### Enhanced Ground Proximity Warning and Terrain Profile

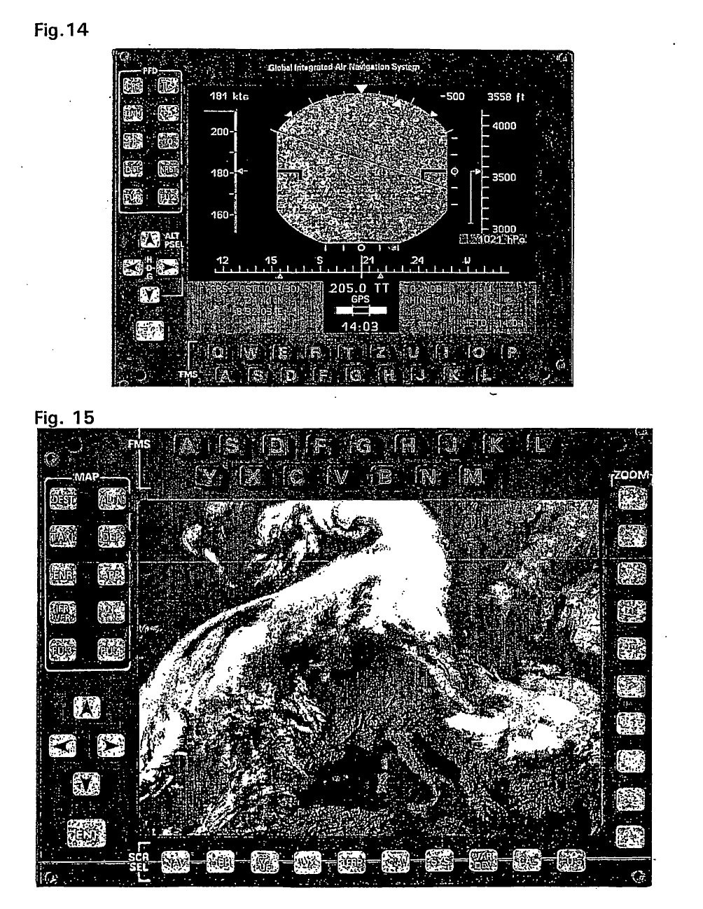

Though the pilot sees the terrain on some maps on the navigation display, the pilot may want to be warned of the terrain below and before getting closer than a certain safe distance. The aircraft's flight path is continuously compared with the GIANS internal terrain database. The terrain clearance is calculated and graphically displayed together with the terrain height profile on track. The pilot will be visually and acoustically warned well in advance if a terrain conflict arises. Furthermore, the pilot can scan the terrain 360° around the aircraft to search for the best terrain clearance. The unique GIANS integrated forward looking EGPW/TP has a great safety aspect and will help avoid controlled flight into terrain (CFIT) (FIG. 14).

### Future ATC Improvements

The System is prepared for ATC related GNSS based data communication, data uplink and downlink to and from the aircraft and between aircrafts, allowing the aircraft to operate in internationally linked automatic air traffic management systems (ATM), omitting expensive ground stations, e.q. RADAR, VOR, DME ILS, MLS, NDB, LORAN, OMEGA, etc., and also airways. Separation will be reduced and airspace capacity improved. The link can also be used for collision avoidance in the air and on ground as well as for apron positioning and company related data communication.

### Automatic Flight Log

An automatic flight log stores the aircraft's place of departure, date and T/O time and place of arrival, date and landing time as well as the elapsed flight time. This enables the aircraft operator to have access to a complete and precise recording of all flights.

On customer request the log may be extended to a flight recorder where all details including keyboard entries are stored and recallable.

### Advanced Primary Flight Display

GIANS represents a complete stand alone flight deck equipment including an advanced PFD with FMS functions and the following fine information and features. There is a horizon compass with automatic deviation and variation compensation, selectable magnetic track, true track or grid, heading bug, automatic direction bug (coupled with an activated flight plan, autosearch or any other navaid), altitude, altitude preselect, ground proximity warning on the altitude scale, vertical speed with vector indicator, true air speed with aircraft limits, ground speed, slip indicator, time in UTC, from/to FMS windows with continental or worldwide database and flight plan coupling, course, distance and estimated time, rotating ‘To’ needle (similar to an RMI), and ILS indicators or ILS tunnel guidance. Instrument landing guidance may be taken from the internal conditioned differential GNSS signals or from conventional external ILS receivers. The PFD is normally displayed on the upper screen but may also be switched to the navigation display (FIG. 15).

Further improvements are discussed.

### Satellite Weather

After the pilot has done a preflight weather briefing the weather may change rapidly and the pilot may encounter entirely different conditions than forecasted. Since weather information is of greatest importance the pilot may want to receive live and in-flight the newest actual satellite pictures to plan ahead. Wherever the position around the world is, in-flight or on ground, this is possible with the satellite weather option (FIG. 15).

### 3-D Terrain

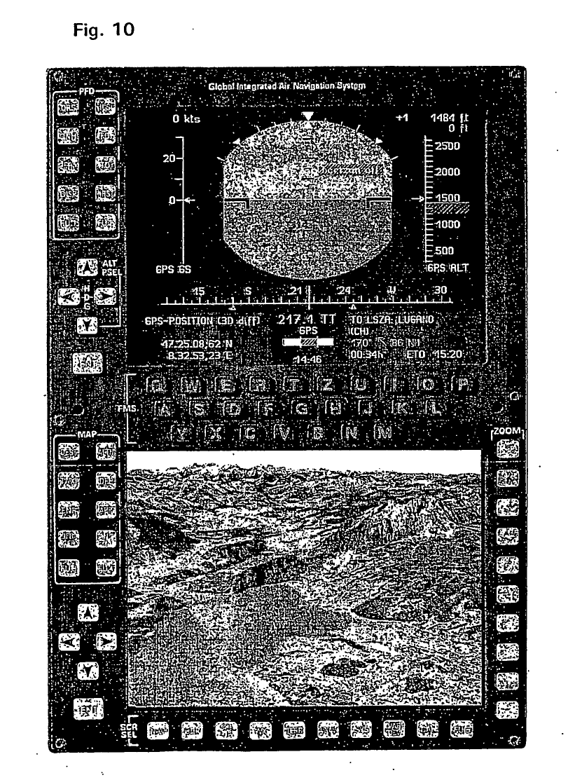

This feature allows the pilot to see the real 3-D terrain moving in such a way as the pilot would look out of the pilot cockpit windows. Especially when the pilot is in full IMC or at night it is a tremendous feature of safety (FIGS. 10 and 11).

### Communication

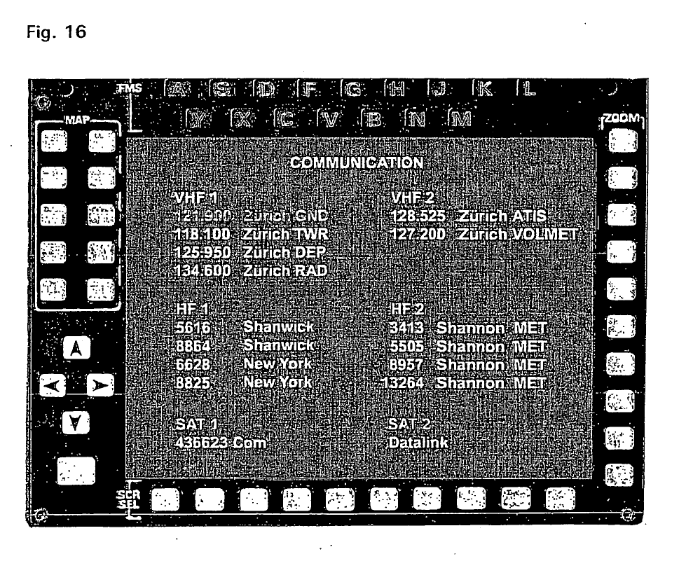

This feature allows the pilot to perform VHF, HF and SATELLITE short and long distance communication (FIG. 16).

### Engine Instruments

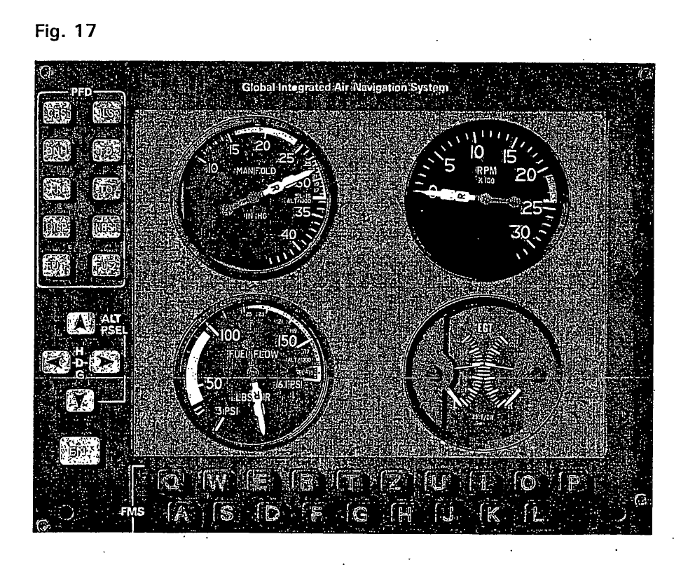

This feature allows to display jet or piston engine instruments either in analog round type or vertical type presentation (FIG. 17).

### Autonomy

The electric System in an aircraft is quite reliable. Still there are a few complete electrical failures that happen. Should the pilot want to be safe there is an optional custom battery pack that enables to continue normally with all system features for the amount of time chosen by the pilot. This makes GIANS to a complete stand alone navigation and flight control system working entirely independent of other cockpit avionics and aircraft power supply.

### Software of GIANS

All functions are made possible by the integrated GIANS software and are described with program functions as follows. The software realizes a navigation system for civilian aviation. It is according to the latest knowledge and techniques and has to simply be able to tie future expansions, built up in modular way.

Two industry computers (CPU) serve as a platform on a VME bus base, OS9 as Operating system, different I/O expansions, a keyboard as well as a graphics card for each of the two screens. Each CPU has its own SCSI adapter, which accesses a common hard disk, and each CPU its own Ethernet network board.

The communication between the two, otherwise independent systems, is realized via UDP reports, bus-like, over the Ethernet cards. Outside programs also can use this bus for e.g. logging or test inputs.

The same processes run by the majority on the two systems. Some processes, which need a specific hardware connection will be started only in the corresponding system. The GPS process to which a GPS is also attached is started only on the system so it behaves similar to air data and keyboard processes.

On the first system (FIG. 1, top) there is primarily a compass for a PFD, the first system artificial horizon, altitude, speed, etc.

The second system (FIG. 1, bottom) serves as a navigation, document and system screen and it can be changed between different display screens.

In emergency cases, the two screens can be mixed up to, e.g. with the failure of the first screen/graphics map, not miss the PFD.

A keyboard, which is arranged around the two screens is available for the interaction with the user or pilot. A second keyboard is optional, which can be placed in the cockpit.

Different data sources as well as the internal data bases (Maps, Waypoints, ILS path, Terrain) provide the program with the necessary information for the different screen modes (FIG. 17).

### Configuration

Every CPU starts itself, and OS9 is booted automatically. As “tsmon” a process is automatically started (mymon). After some seconds of a waiting period, the first user is logged in and a file/dd/SYS/password is accessed.

The Login script of the first user initializes the basic variables, among others GIANS. CONFIG, this as the file name which the configuration file specifies.

For every CPU an own configuration file can be specified, such as gians1.cnf for the left CPU (PFD) and gians2.cnf the right CPU (MAP).

Then the full software is started. These shall not process could, e.g. because they are not needed on the local system, be indicated over the command line (e.g. NOGPS NOAIRDATA) to get started.

The memory modules get established, loaded (Waypoints, Maps) and the processes started. Then the program is finished.

### Program Construction

The GIANS software comprises different program modules each as a single OS9 process. The modules communicate via common memory areas (data modules) with each other, UDP reports as well as signals.

Because the same processes run in the two systems, the description can be reduced on a single system. Every system can take over the function of the other one.

The configuration file reads [n]. DAT, to carry out fundamental attitudes. Under [n] is to understand the number of the system: 1=on the left/PFD, 2=on the right/MAP.

The program prepares common memory areas and starts/stops the individual program modules. The modules end themselves as soon as all modules are started and there is no other need.

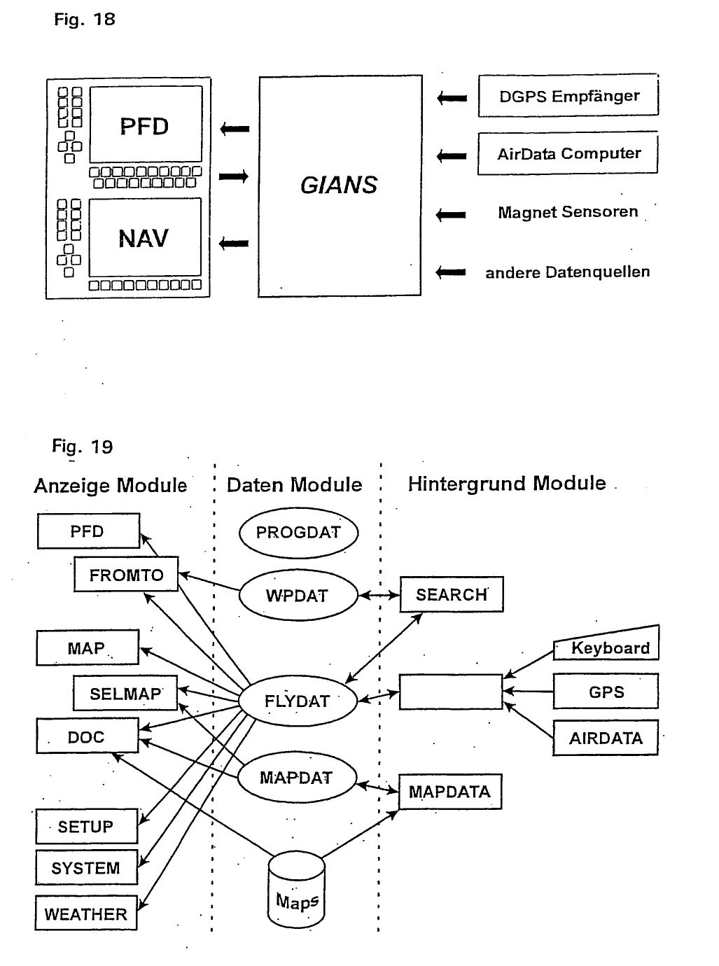

The following graphic illustrates the ensemble playing between the single program modules and the common memory areas (data modules) (FIG. 18).

### Data Base

In GIANS the disk system is used as a DB system. A separate DB Engine here makes little sense because all search functions (Queries) can be done themselves in the RAM of the main processor and it has to be accessed by single files only.

### Waypoint

Waypoints are a list of airfields navigation helps (radio beacon VOR, NDB), or also other points of interest (towns, mountains).

All Waypoints have the same structure and are different only with regard to the contents. The entire list of all Waypoints is fed and put down to WPDAT into a data module by the process of start at program start. They are sorted according to names. GIANS finds the Waypoint-file WP file as the new proceedings of [n]. DAT in the configuration file due to the parameter.

In the data module they are available for the individual program parts and are read only during the operation.

A Waypoint file is made by the PC program NavBase (see PC aid programs) due to user inputs or ARINC files (e.g. of Jeppesen).

### Map

All maps in Giant to be displayed first have to be converted into a format, added by alphanumeric details of and measured before.

This can be performed by the programs MakeMap and ViewMap. (see OS9-help programs).

The maps comprise a header (MAPHDR) and 1 to 6 zoom steps. Every zoom step then comprises a header (ZOOMHDR) on which the real picture data follows the map. Every pixel covers exactly one byte in which 6 steps are available per color channel (RGB).

The files are now available in uncompressed form. There would be one suitable compression proceedings (JPEG). However it could be necessary to reduce the amount of data to accelerate, in the future.

In the MAPHDR information is provided such as the description of the map, airfield sign, country etc. and also PickingRect (active map region) with 4 measuring points, which make possible an assignment of pixel to geographical position.

Information about the single zoom step (breadth, height) is in the ZOOMHDR.

It also has to store place into this for a field around the last position in the Librarymodus to place it at the next start, as the user has seen it before.

At the program start all MAPHDR are fed and put down to one data module called MAPDAT by the process of the startup of all the Maps. GIANS finds the Waypointfile due to the parameter Map_Dir=[n]. DAT in the configuration file in which several lists can be indicated. They are at the individual program parts disposal and are only to read there.

### Terrain

There is not yet fixed format for the terrain data. The representation of the terrain is in the test phase, at present. Terrain data must certainly be defined by characteristic format with a header, which does describe what file and the real content.

A program then is also needed to prepare the files.

Data modules are used, including the following.

### PROGDAT

The PID of the individual processes as well as the ID of the current processes is summarized in PROGDAT. A process can send to another process a specific signal within the system.

### FLYDAT

All data to the current flight situation and position as well as program statuses and values calculated are summarized in the data module FLYDAT. Additionally, the attitudes fed by the configuration file. DAT are provided with to FLYDAT in a sub-structure for all other processes.

The individual data sources (GPS/air data) also put hits data into own sub-structures of FLYDAT. Information is provided by FLYDAT for the further calculation by the program whenever required.

Every program module uses FLYDAT. It is the most central and most important data module within GIANS. In it global, process general data are saved.

### WPDAT

The data module contains all Waypoints in a sorted order. Waypoints generally are points, which are for the navigation of interest. Traditionally, radio beacons (VOR, DME, BS, etc.) are described as a Waypoints. In GIANS airfields, towns, mountains and other country markings also can be used as a Waypoints.

For generating and servicing the Waypoint data base, there is a MS Windows program NAVBASE that can import Jeppesen data in the ARINC format, completed with own data and can change them into a format for GIANS.

In the future, also ILS are data for of single runways can be used for the visualization of trace channels.

Waypoints are fed by the module GIANS at the system start and then remain unchanged during the complete program execution time. Today waypoints are used only in the PFD. The program module FROMTO serves the choice of Waypoints within the PFD.

In the future a flight schedule module can be provided, which e.g. can list all Waypoints between a take-off place and an arrival airport, automatically.

The maps announced at the new method and documents are saved in a format of one's own, this both reconciles alphanumeric data, position data and also pictures for the individual zoom steps. The maps are made from TIFF pictures and by the aid program MAKEDAT and measured by the aid program MAKEDAT. Thereafter they are at the disposal in a list of their own for the application. At the start of the program, the list searched and all headers of the map files read and stored in the data module MAPDAT. Any time they are available for the automatic or manual map choice.

The data module includes an entry for every map being available with the header of the map file.

The module SELMAP uses the header list as the user can select for either the navigation screen MAP or the document view DOC. Furthermore the module is used at the actual needed map to store intermediately for the displaying.

### Program Modules

All program modules get started by the process of GIANS. However, they also can be stopped one by one and started again without interrupting the whole process. This is necessary only during the development and the test phase.

Every program module writes its own PID into the data module PROGDAT as soon as it started successfully and has been initialized. Faults can be recognized by the start process of GIANS. The start process can be interrupted and recorded.

Every program module disposes signals of other processes to the current signal processor.

Signals serve to activate processes (take into the foreground) and to deactivate or, to end (for test purposes) and to inform about keyboard entries or other events.

The modules GPS and the module AIRDATA communicate cyclically with the corresponding data sources and the module KEYBOARD reads possible keyboard entries. The information obtained is sent out as UDP reports on the Ethernet bus where it can be fed to and used by the module INTERCOMM of the other modules also in the 2nd system.

The central module INTERCOMM processes these reports, makes calculations and provides the results for the display modules to the common memory areas. The module is the real coordinating point for the user interaction and the data coordination.

The module SEARCH, in the background, searches permanently the Waypoint database around that one of the current position of airfields seeming most reasonable and other Waypoints.

The indices thereof are put down to the common memory areas to be mostly reprocessed by the display process PFD when required.

The module MAPDATA loads a new map or zoom step into the common memory area MAPDAT (upon request by MAP). The desired zoom step of the desired map is loaded, starting out from the current position. At completion a signal, which announces the completion, is sent to the display module MAP.

The signal give 2 types of requests:
Quickload: Only a small area is loaded around the current position to be able to build up a display screen as fast as possible; and
Normal: A larger area is loaded around the current position.

### GPS

The GPS process initializes the GPS at the start of the program via the serial connection fixed by the configuration file. The GPS sends reports in the standard format (ASCII) periodically, which are interpreted constantly and stored into the sub-structure Gps (GPSDATA) of the global data module FLYDAT. Depending on the mode, other reports are requested from the GPS. Position data is usually required with a higher priority than status data.

However, the status screen is active, the frequency of the status reports is increased and the frequency of the position data is reduced, so that the status of the position of the satellites and the reception quality of the individual satellites can be displayed.

### AIRDATA

The AIRDATA process opens the connection to the AIRDATA computer at program start via the serial connection fixed by the configuration file. The AIRDATA computer sends reports periodically to be interpreted constantly and be put into the sub-structure of AIRDATA of the global module FLYDAT. The AIRDATA computer finds data out from air pressure and jam pressure as well as other equipment attached externally and transmits it to GIANS.

### MAGNETO

The MAGNETO process opens the connection to the MAGNETO computer at program start, over the serial connection fixed by the configuration file. The Magneto sensor sends reports periodically which are interpreted constantly and put into the sub-structure like (MAGNETO) the global data module FLYDAT. The sensor determines the magnetic horizontal situation of the airplane. If the flight situation is not inclined (lengthways or crossways) the details must be corrected accordingly.

### Intercomm

The process Intercomm listens or receives permanently to the UDP bus, reads all reports and interprets them. The process makes the necessary calculations, activates other processes and serves as a real central control station of the system.

The following reports can be distinguished.
KEY: Keyboard events, a button was pushed.
GPS: a GPS report has come in.
AIR: a report of the air data computer was read.
Lied: a logging report was sent: ignored.
DBG: a debug report was sent: ignored
MAP: a report of the magnet sensors has come in.

### Search

That process searches all Waypoints periodically and finds the next 5 airports as well as the nearest waypoints. The data found is put in the global MemoryModul FLYDAT where they are at disposal of the other processes (mostly PFD).

### MAPDATA

MAPDATA remains inactive until the process is activated by the process MAP by a signal. This can be the following events.

Reload: A map part is read and can be made available in the global Memorymodul MAPDATA.

In the field SelMap the map to be loaded is specified. In the fields SelZoomPos/SelXPos/SelYPos the desired zoom position as well as specified map position in the fields gets specified.

Calibrate: An offset can be defined in longitude and latitude, which is taken into account at positioning of the map on the screen. Map faults still can be reduced to the running time.

The process MAP gives the correction values into the fields SelXcal/SelYcal of the structure.

The process MAPDATA stores these correction values of the corresponding Map file on the hard disk.

Reset Calibration: That function resets the correction values of a map back to 0 again so that the original state is achieved again.

### PFD

The PFD process represents the Primary Flight Display (PFD) screen. It contains Altitude, Vertical Speed, Ground Speed, horizon, compass, drift as well as FROM-Waypoint and TO-Waypoint displays.

The PFD is usually active on the upper screen (left CPU). The process makes use and represents the mentioned instruments from the global Memory module FLYDAT. For the choice of FROM- or TO-Waypoint the independent process FROMTO is used.

The process is divided up into the following different individual modules, which are aware of one isolated function each.

PFD. C is a main module for building windows, drawing of texts and interaction with other processes and works with 2 windows (double buffering). One is visible while the other is built up. When it is finished, the second window is swapped. This makes a display without flickering.

BARS. C R is a representation of a range for TAS and ALT. The ranges are drawn into own windows, which then are displayed in the PFD.

HORIZONT.C is an artificial horizon that is drawn into a bitmap of its own and then it is transferred into the current window of the PFD.

ILS. C draws the ILS trace channel into the PFD.

ILSDATA. C contains some constants for the representation of vector numbers.

KOMPASS. C draws the compass into a 540 degrees wide window, which is placed so that the current direction of flight is visible. Hdg bug as well as To bug are represented on the compass scale.

### FROMTO

The module serves for a choice of Waypoints for the advertisement in the FROM or TO fields of the PFD.

It is built as an own process to not interrupt the display in the PFD while a Waypoint is chosen.

The process INTERCOMM sends the keyboard signal to FROMTO for activating after pressing the button VK_FROM or VK_TO.

FROMTO thereafter opens a window at the appropriate place on the screen in which a user can choose a Waypoint. These are visibly always 4 Waypoints in the window at the same time. The current one is marked by an inverse representation. The user has the following methods for browsing through the list of the Waypoints.

Button up/down for scrolling one entry each up/down.

Input of letters to jump on the second, third, fourth or fifth letter or what, within some seconds after the first letter.

By pushing the enter key the current Waypoint is selected and written in FLYDAT.

The same button as for the activation is pressed again (VK_FROM or VK_TO) the FROMTO window is closed without having to make a selection. The window is closed automatically after some time, without user interactivity.

In the two cases the previous advertisement in the From/To field of the PFD remains unchanged.

Whether the FROM- or the TO-Waypoint should be chosen, the user in addition to the list of the Waypoints is able to choose the following.
FROM: ACTUAL position autom. of the current position.
TO: NEAREST POINTautom. to the next Waypoint.
FLIGHT PLANautom. to the next Waypoint of the flight schedule (if FPL completed).

### MAP

The process MAP usually displays on the lower screen (right CPU) a map on with the current flight position.

The current flight data (course, position, etc.) are displayed in a header line and information about the displayed map (zoom position, scale) in a foot line. The map is turned corresponding to the direction of flight. By the function North-Up a northward directional display also can be forced. The choice of the map is usually carried out automatically with the current position, the current flight status (cab, take-off, flight, trace, cab), as well as the flight mode (VFR/IFR). However, a manual choice also can be carried out by the module SELMAP. The user can overmodulate the automatic choice of the maps.

If it is foreseeable that one is flying out of the current map soon, the background process MAPDATA, which feeds a new map and thereafter informs and activates the process MAP by a signal again. The direction of flight and speed is taken into account. The function CalibrateMap allows the user to fix an offset graphically in x and y direction. Then the offset writes it by the process MAPDATA into the respective Map file.

The MAP program is divided up for reasons of the clarity and partly for historical, reasons into the following different modules.

MAP.C: Main module, window building, drawing of title and footnote as well as interaction with other processes.

It works with 2 windows (double buffering), one is visible while the other gets finished. If the second window is finished and ready then they are swapped. This makes a flickering free display possible.

MAP_CAL.C display for calibrating of a map manually by means of a mobile reticule. The correcting values are submitted to the independent process MAPDATA, which writes it into the corresponding MAP file.

MAP1.C: Display of the map inside a round compass. This view still dates from earlier stages of development of the GIANS project. MAP2.C: Display of the map inside a rectangular compass. This view still dates from earlier stages of development of the GIANS project.

MAP3.C: Current display of the map.

MAPCALC.C: Calculation functions for the display of the map.

MAPTOOLS.C: For reasons of the clarity some functions were moved into this module since they could be used by other, later views. For example, a representation of the airplane symbol, the zoom step, etc.

### DOC

This module DOC serves the general representation of documents necessarily for the navigation and guidance of the pilot and are helpful (maps, check lists, Meteo information etc.).

Therefore it also is described as a Library function.

The current position is not as important as in the MAP display.

Every document is filed in the format of the GIANS maps and can be called and displayed by the user freely.

All zoom steps already provided by the file are available. In every document there is a zoom step, which takes a document as whole into the screen. If a more exact zoom step is chosen, the rectangle can be selected by the arrow buttons and chosen with the enter key for the new desired zoom step.

If a zoom step cannot be displayed, scrolling is possible by the arrow buttons. Scrollbars on the right/lower picture edge show the dimension and the position of the currently visible part within the complete document.

The choice of the document is made possible by the module SELMAP in the same way as in the module MAP.

### SELMAP

The process allows to select a map. This function is used by MAP as well as by DOC. The maps of the current position (MAP) or all maps, listed to country and airfield (DOC) are listed.

The user can select a map by arrow buttons.

Only those maps are listed, which are corresponding to the desired map type (cab/Departure/Enroute/Approach/Doc) as well as to the flight mode of (VFR/IFR).

The number of the chosen map is written into the global Memorymodul. The process, activated by the SELMAP, will be informed by a signal.

The process can read the chosen map-no from the Memorymodul and display it (respectively request it by MAPDATA).

### Set-Up

The process permits to carry out attitudes during the air traffic.

The time, deviation augmenters as well as the magnetic variation can be entered.

Deviation augmenters are represented in a table for 8 different positions. The button ‘G’ draws a deviation graphic for full 360 degrees.

The settings are stored in a file, which the names are fixed by the parameter ‘CAL file=’ of the configuration file. So they are furthermore available.

### System

The process shows inputs received of the different sensor groups.

Magneto values, A/D values, acceleration values as well as details on the GPS reception are displayed.

This display will be activated at the system start until sufficient satellites for the 3D navigation are available.

After the view is further switched to MAP.

### Weather

The Weather process is provided for the display of a weather picture, which is received from weather satellites. At the moment only a static picture is taken to the screen and shown (a stored one) from a BMP file (/h0/GIANS/DATA/satbild.bmp).

### Library Stuff

As an overview, functions of the Library STUFF. L. are needed by all program modules.

The Library offers a variety of functions, which are used by the different individual modules.

It is a normal OS9-Library having the individual ‘.r’ modules.

The Includefile STUFF. H include almost all definitions and declarations of the individual Library parts.

### MODULES.C

Here are some functions, which make the ensemble playing possible of single program modules.

These are functions, which on the one hand permit the Linking and Locking of the single Memory module as well as Debug and Log functions.

### GDP.C

To standardize, the window treatment and platform independently are served by the functions in GDP.C. The functions permit the opening of windows to close or hiding, filling windows or, writing text. The graphic functions used are also generally here.

The function permits the display of texts written in any angle.

E.g. this is used at the indication of the artificial horizon the PFD.

### MATHFUNC.C

Some mathematical functions are summarized in this module. They are predominantly functions for the conversion of angles of rad in degree, in 1/10 degrees etc.

Furthermore here are the functions, which permits the exact time measurement in 1 ms dissolving. This is useful for performance regulations.

### Strings.c

In Strings.c are put the functions for the string treatment.

### VCHAR.C

The data in VCHAR. C serve for character-type used everywhere. For each of the 256 possible characters strokes are defined here, which lines, indicated in pixels exactly, are needed for a character. These details are used in continuation with functions in GDP. C so that the dimension and orientation of texts be drawn as whished, scaled and revolved. The data originally are from VCS (manufacturer of the graphics maps) and are adapted for the needs in GIANS.

### SINTAB.C

The module contains a table with a value for every 1/10 degree, which corresponds to the sin (angle) of *2¹⁶. This is carried out by the MATHFUNC. C to be able to perform fast turns (MAP. C).

Aid programs each have 4 functions, which are determined by the first call parameter.

### Start

Sets up all memory areas and starts all program parts belonging to GIANS. By further parameters are allowing to exclude single program parts of it. (i.e. START NOGPS starts all processes except for GPS).

### Stop

All GIANS processes are stopped and the memory areas deleted.

### Test

Serve for testing the system. In a menu single system parameters can be changed or a flight can be simulated by entering the parameters interactively by the keyboard (terminal).

### Logo

Serves testing the logo displayed at the program start.

### MakeMap

MakeMap is a program, the scanned maps in a TIFF or COT format converts into the GIANS format and generates the necessary zoom steps simultaneously.

With MakeMap also the header information, i.e. the alphanumeric information (name, airfield, country etc.), can be edited, which is stored in a map file.

MakeMap is used by the keyboard (terminal) and also distributes a menu to the terminal. It is the only utility to convert map format into the GIANS. A Windows program would desirable.

### Viewmap

The program serves for measuring the scanned maps, which are processed by MAKEMAP.

For the first parameter it gets the name of an existing Gians Mapfile.

The map is thereafter displayed by keyboard commands and it can be zoomed in and scrolled. Additionally, a reticule can be placed exactly and a measuring point that can be defined. For example, the assignment of pixel to length/breadth can be fixed. Every map has 4 measuring points, also smaller twists can be corrected.

VIEWMAP is used by the keyboard (terminal) and also distributes a small menu. The first graphics map is always used for the display of the map.

### PC Aid Programs

NAVBASE: The program NAVBASE was made for Windows 3.1× and is able to read Jeppesen Waypoint data in the ARINC format. The Waypoints can be edited and can be exported in the format of GIANS (OS9). The program therefore can care for the stock of Waypoints.

The program for Win32 permits to send keyboard entries by UDP reports, so that the GIANS flight program treats them as if they had been sent by the real keyboard. The complete keyboard is shown on the screen and single buttons can be pressed by the mouse. Exiting single programs by menu order is possible.

### UDP

The program for Win32 permits to listen for and to record UDP reports on the GIANS, Intercomm bus. It can have stored sequences of UDP reports read back again so that former conditions can be comprehended.

### Development System

PC: The PC program OS9.EXE writes on the PC with any program editor and can be compiled by a customary Make utility.

It runs under Windows NT 4.0. With it, program modules, which are changed can be sent to the OS9 system and can be compiled there.

1. A method for a navigation of airplanes from port to port using GPS signals, the method comprising: the navigation being effected with an integrated Flight Management System (FMS) based on digital cards and a position determination by GPS signals corrected by GPS reference signals, wherein depending on a momentary position and movement condition of the airplane a card on which a movement is based is automatically selected from a library and displayed on a screen.

2. A method according to claim 1, wherein when the airplane is on an airfield one of standing and rolling, a correct airfield map is displayed on the screen, during a departure procedure, a correct departure map is displayed on the screen, when the airplane is in enroute, a correct one of IFR, VFR and another map is displayed on the screen, and for the approach a correct approach map is switched on and upon landing automatically a correct airfield map is switched on.

3. A method according to claim 1, wherein as an approach and landing help, a GNSS 3-D trace channel is displayed on the screen, wherein a trace channel is set by geographic data and is coupled to an approach map, wherein the trace channel is continuously calculated by differential-GPS data and is displayed.

4. A method according to claim 3, wherein terrain data from a terrain data base are displayed in a representation of the trace channel.

5. A device for carrying out the method according to claim 1, wherein the device comprises the FMS (flight management system), a differential GPS receiver, a computer with navigation. software, a database with digital maps and at least one screen for displaying a map, and entering keys.

6. A device according to claim 5, wherein another screen displays different flight and navigation aids, including IFR instruments, artificial horizon, and engine instruments.

7. A device according to claim 6, wherein the instruments to be displayed are selected and operated by buttons.

8. A device according to claim 5, wherein a digital library comprises all maps necessary for flights, airfield data, terrain data and data of further navigation aids.

9. A device according to claim 8, wherein the digital library comprises flight manuals, check lists and technical documents.

10. A device according to claim 5, wherein the navigation software is built up in modules and comprises program modules.
